(19) United States
(12) Patent Application Publication
(10) Pub. No.: US 2005/0181225 A1
(43) Pub. Date: Aug. 18, 2005

(54) Use of block copolymers bearing phosphate and/or phosphonate functions as adhesion promoters or as protecting agents against the corrosion of a metallic surface

(76) Inventors: Mathias Destarac, Paris (FR); Cecile Bonnet-Gonnet, Lyon (FR); Arnaud Cadix, Paris (FR)

Correspondence Address: Jean Louis Seugnet;Intellectual Property Department, Rhodia Inc CN 7500, 259 Prospect Plains Road, Cranbury, NJ, 08512-7500, US

(21) Appl. No.: 10/507,330

(22) PCT Filed: Mar. 12, 2003
(86) PCT No.: PCT/FR03/00788

(30) Foreign Application Priority Data
Mar. 13, 2002 (FR) 02 03111

(51) Int. Cl. B05D 7/00; B05D 1/18; B21C 1/00

(52) U.S. Cl. 428/544; 427/384; 427/430.1

(57) ABSTRACT

The invention relates to the use of a block copolymer having at least one block that comprises phosphate and/or phosphonate functions in order to produce a deposit on a metallic surface, such as a steel or aluminium surface, which can be used, for example, to improve the effectiveness of the subsequent application of a film-forming composition on the thus altered surface or to protect the metallic surface against corrosion. The invention also relates to a method of applying paint or mastic compositions to a metallic surface, which involves the above-mentioned inventive use of said block copolymers, and the coated metallic materials that can be produced using said application method.

The present invention relates to the use of a block copolymer, at least one block of which comprises phosphate and/or phosphonate functional groups, for producing on a metal surface, such as a steel or aluminum surface, a deposited layer which can be used in particular for improving the effectiveness of the subsequent application of a film-forming composition to the surface thus modified or for protecting said metal surface from corrosion.

The invention also relates to a process for the application of paint or mastic compositions to a metal surface which takes advantage of this type of use and to the coated metal materials capable of being obtained according to such an application process.

The term “metal surface”, within the meaning of the invention, is to be understood as the surfaces of materials based on metals or on semimetals.

The term “metals” is understood to mean, in the present invention, any substance which is distinguished from nonmetallic substances by a high conductivity for electricity and heat, this conductivity decreasing with a rise in temperature, and by their high reflectivity with respect to light, which gives them a characteristic metallic sheen.

Mention may be made, as examples of metals or semimetals, of the elements of the Periodic Table of the Elements listed in the table on page 227 of the document entitled “Encyclopaedia Britannica”, Volume 15, 1966, incorporated by reference.

Mention may in particular be made of the elements of the Periodic Table of the Elements chosen from the group of the alkali metals or alkaline earth metals, the transition metals, aluminum, gallium, indium, thallium, silicon, germanium, tin, lead, arsenic, antimony, bismuth, tellurium, polonium or astatine, and their oxides or their alloys.

Mention may be made, as preferred list of metal materials, of aluminum, duralumin, zinc, tin, copper, copper alloys, such as bronze or brass, iron, steel, optionally stainless or galvanized, silver or vermeil.

When a film-forming composition of paint or mastic type, optionally comprising silicone, is applied directly to the surface of one of these metal materials, poor anchoring of the film-forming composition to the metal surface is generally observed, which results in a coating of mediocre quality being obtained.

Furthermore, it is also possible to observe, in the case of materials comprising iron, such as steel, flash corrosion brought about by the direct application to the metal surface of a film-forming composition of paint or mastic type, optionally comprising silicone, in particular when it is an aqueous composition, which has a considerable detrimental effect on the quality and the durability of these coatings.

Moreover, an additional problem arises in the case of materials made of aluminum, which is the very low wettability of the aluminum surface, which makes it impossible to directly apply a film-forming composition of paint or mastic type, optionally comprising silicone, to the surface of a material made of aluminum or else results, in the best of cases, in a coating of mediocre quality being obtained.

Furthermore, the properties of adhesion of the coatings thus obtained deteriorate in the presence of moisture or on contact of these surfaces with water, in particular because of phenomena of diffusion of the water at the interface.

The need existed to improve the properties of adhesion to metal surfaces.

In point of fact, the Applicant Company has discovered that some block copolymers, at least one block of which comprises phosphate or phosphonate functional groups or their mixtures, can be used to produce, on metal surfaces, deposited layers exhibiting a strong affinity with respect to these surfaces and which modify the properties thereof, in particular by enhancing their ability to anchor and/or by increasing their wettability and/or by conferring thereon a more hydrophilic or more hydrophobic nature and/or by providing protection from corrosion.

The modifications induced by the presence of a deposited layer based on these block polymers make it possible to alleviate the problems encountered to date and it is possible to obtain an improvement in the effectiveness of the application of a film-forming composition of paint or mastic type but also an improvement in the adhesion to the support of this film-forming composition which is effective and lasting, even in the presence of water.

This improvement in the adhesion of the coating is reflected by a prolonged decorative, protective or functional effect, advantageously throughout the lifetime of the product, without the effect induced by the coating produced being capable of being threatened by washing with an aqueous solution (S) with a pH of between 1 and 12, optionally comprising sodium chloride, in a proportion of a maximum concentration of 10 M, peeling or disintegration of said coating, in particular under the effect of mechanical stresses.

More generally, the deposited layer based on the block copolymers of the invention generally has an affinity with respect to the metal surface such that this deposited layer remains firmly attached to the treated surface for relative humidities ranging from 0 to 100%. Advantageously, the deposited layer remains firmly attached in the presence of water, indeed even under immersion in water.

Due to the modification in the surface properties which they bring about, and taking into account their behavior toward water, deposited layers based on the block copolymers produced according to the invention can be employed in numerous fields of application.

Thus, according to a first aspect, a subject matter of the present invention is the use of a block copolymer, at least one block of which comprises phosphate and/or phosphonate functional groups, said copolymer optionally being dissolved in a solvent, such as an organic solvent, water or a water/alcohol mixture, to produce, on a metal surface, a deposited layer which increases the affinity of said surface with respect to water.

The term “increase in the affinity of a metal surface with respect to water” is understood to mean an increase in the wettability of said surface by water and aqueous solutions. This increase in the affinity for water is usually accompanied, more generally, by an increase in the wettability by polar solvents other than water, such as glycerol.

This increase in the wettability subsequent to the deposition of the block copolymer of the invention is demonstrated by measuring, under the same temperature and relative humidity conditions, the contact angle presented by a drop of water deposited on the surface, before and after the deposition of said copolymer.

The increase in the wettability of the surface observed subsequent to the deposition of the block copolymer on the surface is reflected by a decrease in the contact angle measured in comparison with the angle measured before this deposition.

Thus, under relative humidity conditions of 0 to 100% and at temperatures of 15 to 35° C., the deposition of a block copolymer according to the invention makes it possible, for example, for a surface of aluminum type, to pass from a contact angle of a drop of water of 93° to an angle of 51°.

The block copolymer of the invention can advantageously be employed to confer a hydrophilic nature on a surface initially exhibiting a hydrophobic nature. The term “surface of “hydrophobic” nature”, within the meaning of the invention, is to be understood as a surface characterized by a contact angle of a drop of water of greater than or equal to 45° and generally of greater than 70°. The term “hydrophilic” is, for its part, employed to denote a surface characterized by a contact angle of a drop of water of less than 45°, preferably of less than or equal to 30°.

Thus, the block copolymer of the invention can advantageously be employed to confer a hydrophilic nature on a surface initially exhibiting a hydrophobic nature, such as, for example, certain surfaces based on aluminum (contact angle with a drop of water ˜90°), on dural (contact angle with a drop of water ˜70°) or on galvanized steel (contact angle with a drop of water ˜80°).

Thus, the invention also relates to the use of a block copolymer, at least one block of which comprises phosphate and/or phosphonate functional groups, said copolymer optionally being dissolved in a solvent, such as an organic solvent, water or a water/alcohol mixture, to render a surface with a hydrophobic nature compatible with its environment with a hydrophilic nature.

A particularly advantageous aspect of the invention relates to the use of a block copolymer, at least one block of which comprises phosphate and/or phosphonate functional groups, said copolymer optionally being dissolved in a solvent, such as an organic solvent, water or a water/alcohol mixture, to produce, on a metal surface, a deposited layer which renders effective and lasting a subsequent application of a composition (F) to said metal surface.

Another particularly advantageous aspect of the invention relates to the use of a block copolymer, at least one block of which comprises phosphate and/or phosphonate functional groups, said copolymer optionally being dissolved in a solvent, such as an organic solvent, water or a water/alcohol mixture, to produce, on a metal surface, a deposited layer which protects said metal surface from corrosion.

The invention thus relates to a process for the application of a film-forming composition (F) to a metal surface, comprising the following stages:
(A) a formulation optionally comprising a solvent, such as an organic solvent, water or a water/alcohol mixture, comprising a block copolymer, at least one block of which comprises phosphate and/or phosphonate functional groups, is applied to said surface, so as to form, on said surface, a deposited layer in the form of a continuous coat; and
(B) the solvent is at least partially removed from the deposited layer obtained in stage (A); and
(C) said film-forming composition (F) is applied to the surface, thus modified, obtained in stage (B).

The deposited layer based on the block copolymer produced according to the invention can be prepared by applying, to the metal surface, a solution comprising said block copolymer or by immersing the surface to be treated in a solution based on the block copolymer, and by then subsequently removing, at least partially and preferably largely, the solvent initially present in this solution, for example by drying.

The term “partial removal” is to be understood as meaning the removal of at least 70% by mass of the solvent initially present, preferably of at least 80% by mass and more advantageously still of at least 90% by mass.

The removal “largely” of the solvent corresponds, for its part, to the removal of at least 95% by mass of the solvent initially present, preferably of at least 97% by mass and more advantageously still of at least 99% by mass.

The solution based on the block copolymer of stage (A) is preferably an aqueous or aqueous/alcoholic solution (for example, in a water/ethanol mixture) in the case where the film-forming composition (F) is an aqueous composition.

The solution based on the block copolymer of stage (A) is preferably a solution in an organic solvent in the case where the film-forming composition (F) is a composition in an organic solvent.

The film-forming composition (F) can also be based on anhydrous mastic or polyurethane.

This solution used, whatever the solvent used, has a concentration of block copolymer of, in the most general case, between 0.01 and 50% by mass. In order to obtain optimum wetting of the support and to avoid the appearance of heterogeneities within the deposited layer produced, it is preferable to use a solution at a concentration of between 0.05 and 10% by mass and more preferably still between 0.1 and 5% by mass.

Such contents confer, on the formulation, a viscosity suitable for application to the metal surface. Furthermore, these contents result in the production of a continuous film (without the appearance of dewetting regions) when they are applied using a film drawer to flat surfaces or, more generally, when the surface to be treated is immersed in said solution.

In addition, these concentrations are particularly well suited to carrying out, by simple drying, partial or complete removal of the organic solvent or of the aqueous or aqueous/alcoholic solvent present in the deposited layer produced in stage (A), which removal is recommended in order to observe an effective improvement in the application of the composition (F) during stage (C).

The drying of stage (B) is carried out, for example, at a temperature of between 15° C. and 50° C. (preferably between 19 and 25° C.) and under humidity conditions of between 10% and 70% and preferably between 50% and 60%.

In the case where the deposited layer of stage (A) is produced using a film drawer, the film obtained has a thickness of between 1 and 100 microns and advantageously between 10 and 70 microns. Thus, the thickness of the film deposited can more advantageously still be of the order of 20 microns.

After the drying of stage (B), a polymer-based deposited layer is obtained which exists in the form of a continuous bonding primer coat with a thickness of between 10 nm and 1 μm, advantageously between 40 and 600 nm and preferably between 50 and 500 nm.

The term “film-forming composition”, within the meaning of the invention, is to be understood as any composition in the form of a dispersion or of a solution, generally in the form of a dispersion where the dispersed phase advantageously exhibits a size of between 10 Å and 100 μm, comprising:
as continuous or solvent phase, an organic solvent or water, optionally in combination with other soluble compounds; and
compounds of polymer or polymer precursor, acrylic resin or silicone type which are capable of resulting in the formation of a polymer film, of an acrylic film or of a silicone film following the application of the composition to a surface and following the at least partial evaporation of the organic solvent or of the water and optionally of the other soluble compounds.

Thus, without implied limitation, the film-forming compositions of the invention can, for example, be aqueous compositions comprising an aqueous or aqueous/alcoholic dispersion of carbonaceous polymers in the form of a latex or of a formulation, of adhesive, mastic or paint type, for example, comprising such a latex, or of silicone precursors and in particular a mastic composition of the type of those disclosed in the documents EP 665 862, WO 98/13410 or WO 99/65973.

The compositions of the invention can also be compositions comprising a dispersion of carbonaceous polymers in the form of a latex or of a formulation, of adhesive, mastic or paint type, in an organic solvent.

During the application of the block copolymers of the invention to a metal surface, the anchoring block or blocks functionalized by the phosphate and/or phosphonate functional groups create chemical bonds with the atoms of the metal surface. These chemical reactions take place on the sites capable of being corroded and, for this reason, bring about protection of the metal surface.

The separate blocks of the anchoring block of the block copolymer make it possible to adjust the condition of the metal surface to the desired application, in particular to increase interactions between the composition (F) and the surface and thus the adhesion energy.

These blocks can additionally comprise one or more chemical functional groups capable of creating lasting chemical bonds with the polymer present in the film-forming composition (F).

Mention may be made, by way of examples of chemical functional groups, of the hydroxyl, epoxy, carboxyl, amino or isocyanate functional groups, which are capable of acting in a crosslinking stage.

The block copolymers of the present invention exhibit at least one block comprising phosphate and/or phosphonate functional groups.

This block, known as anchoring block, can be a homopolymer based on a monomer comprising phosphate or phosphonate functional groups.

The anchoring block can also be a random polymer based on a monomer comprising one or other of these phosphate or phosphonate functional groups or their mixtures in an amount of between 0.1 and 100% by weight of said monomers with respect to the total weight of the anchoring block. Preferably, this amount of said monomers is between 0.5% and 50% by weight of said monomers with respect to the total weight of the anchoring block. More preferably still, this amount is between 2% and 20% by weight of said monomers with respect to the total weight of the anchoring block.

The monomer comprising phosphonates can be chosen, for example, from:
N-methacrylamidomethylphosphonic acid ester derivatives, in particular the n-propyl ester (RN 31857-11-1), the methyl ester (RN 31857-12-2), the ethyl ester (RN 31857-13-3), the n-butyl ester (RN 31857-14-4) or the isopropyl ester (RN 51239-00-0), and their phosphonic monoacid and diacid derivatives, such as N-methacrylamidomethylphosphonic diacid (RN 109421-20-7),
N-methacrylamidoethylphosphonic acid ester derivatives, such as N-methacrylamidoethylphosphonic acid dimethyl ester (RN 266356-40-5) or N-methacrylamidoethylphosphonic acid di(2-butyl-3,3-dimethyl)ester (RN 266356-45-0), and their phosphonic monoacid and diacid derivatives, such as N-methacrylamidoethylphosphonic diacid (RN 80730-17-2),
N-acrylamidomethylphosphonic acid ester derivatives, such as N-acrylamidomethylphosphonic acid dimethyl ester (RN 24610-95-5), N-acrylamidomethylphosphonic acid diethyl ester (RN 24610-96-6) or bis(2-chloropropyl) N-acrylamidomethylphosphonate (RN 50283-36-8), and their phosphonic monoacid and diacid derivatives, such as N-acrylamidomethylphosphonic acid (RN 151752-38-4),
the vinylbenzylphosphonate dialkyl ester derivatives, in particular the di(n-propyl) (RN 60181-26-2), di(isopropyl) (RN 159358-34-6), diethyl (RN 726-61-4), dimethyl (RN 266356-24-5), di(2-butyl-3,3-dimethyl) (RN 266356-29-0) and di(t-butyl) (RN 159358-33-5)ester derivatives, and their phosphonic monoacid and diacid alternative forms, such as vinylbenzylphosphonic diacid (RN 53459-43-1),
diethyl 2-(4-vinylphenyl)ethanephosphonate (RN 61737-88-0),
dialkylphosphonoalkyl acrylate and methacrylate derivatives, such as 2-(acryloyloxy)ethylphosphonic acid dimethyl ester (RN 54731-78-1) and 2-(methacryloyloxy)ethylphosphonic acid dimethyl ester (RN 22432-83-3), 2-(methacryloyloxy)methylphosphonic acid diethyl ester (RN 60161-88-8), 2-(methacryloyloxy)methylphosphonic acid dimethyl ester (RN 63411-25-6), 2-(methacryloyloxy)propylphosphonic acid dimethyl ester (RN 252210-28-9), 2-(acryloyloxy)methylphosphonic acid diisopropyl ester (RN 51238-98-3) or 2-(acryloyloxy)ethylphosphonic acid diethyl ester (RN 20903-86-0), and their phosphonic monoacid and diacid alternative forms, such as 2-(methacryloyloxy)ethylphosphonic acid (RN 80730-17-2), 2-(methacryloyloxy)methylphosphonic acid (RN 87243-97-8), 2-(methacryloyloxy)propylphosphonic acid (RN 252210-30-3), 2-(acryloyloxy)propylphosphonic acid (RN 254103-47-4) and 2-(acryloyloxy)ethylphosphonic acid,
vinylphosphonic acid, optionally substituted by cyano, phenyl, ester or acetate groups, vinylidene-phosphonic acid, in the sodium salt form or the form of its isopropyl ester, or bis(2-chloroethyl)vinylphosphonate.

The monomers comprising a phosphonic mono- or diacid functional group can be used in the partially or completely neutralized form, optionally neutralized by an amine, for example dicyclohexylamine.

The monomer can also be chosen from the phosphate analogs of the phosphonate-comprising monomers described above. These monomers then comprise a —C—O—P— sequence in comparison with the —C—P— sequence of the phosphonates.

Mention may be made, as specific phosphate-comprising monomers, of:
2-(methacryloyloxy)ethyl phosphate,
2-(acryloyloxy)ethyl phosphate,
2-(methacryloyloxy)propyl phosphate,
2-(acryloyloxy)propyl phosphate, and
acrylates or methacrylates of polyethylene glycol omega phosphates or acrylates or methacrylates of polypropylene glycol omega phosphates.

Preference is given, among the phosphonate-comprising or phosphate-comprising monomers which come within the scope of the present invention, to the use of the following monomers:
vinylphosphonic acid,
2-(methacryloyloxy)ethylphosphonic acid,
2-(acryloyloxy)ethylphosphonic acid,
2-(methacryloyloxy)ethyl phosphate, and
2-(acryloyloxy)ethyl phosphate.

The proportion by mass of the anchoring block with respect to the total weight of the block copolymer of the present invention varies between 90:10 and 10:90.

The other monomers of the anchoring block which are involved in the context of the present invention can be monomers having a hydrophilic (h) or hydrophobic (H) nature.

Mention may be made, among monomers having a hydrophilic nature (h), of:
unsaturated ethylenic mono- and dicarboxylic acids, such as acrylic acid, methacrylic acid, itaconic acid, maleic acid or fumaric acid,
monoalkyl esters of the above unsaturated ethylenic dicarboxylic acids, preferably with C₁-C₄ alcohols, and their N-substituted derivatives, such as, for example, 2-hydroxyethyl acrylate or methacrylate,
amides of unsaturated carboxylic acids, such as acrylamide or methacrylamide, or
ethylenic monomers comprising a ureido group, such as ethylene urea ethyl methacrylamide or ethylene urea ethyl methacrylate, or
ethylenic monomers comprising a sulfonic acid group or one of its alkali metal or ammonium salts, such as, for example, vinylsulfonic acid, vinylbenzenesulfonic acid, α-acrylamidomethyl-propanesulfonic acid or 2-sulfoethylene methacrylate, or
cationic monomers chosen from aminoalkyl (meth)acrylates or aminoalkyl(meth)acrylamides; monomers comprising at least one secondary, tertiary or quaternary amine functional group or a heterocyclic group comprising a nitrogen atom, vinylamine or ethyleneimine; diallyldialkylammonium salts; these monomers being taken alone or as mixtures, and in the form of salts, the salts preferably being chosen such that the counterion is a halide, such as, for example, a chloride, or a sulfate, a hydrosulfate, an alkyl sulfate (for example comprising 1 to 6 carbon atoms), a phosphate, a citrate, a formate or an acetate, such as dimethylaminoethyl(meth)acrylate, dimethylaminopropyl(meth)acrylate, di(tert-butyl)aminoethyl (meth)acrylate, dimethylaminomethyl(meth)acrylamide or dimethylaminopropyl(meth)acrylamide; ethyleneimine, vinylamine, 2-vinylpyridine or 4-vinylpyridine; trimethylammonium ethyl(meth)acrylate chloride, trimethylammonium ethyl acrylate methyl sulfate, benzyldimethylammonium ethyl(meth)acrylate chloride, 4-benzoylbenzyldimethylammonium ethyl acrylate chloride, trimethylammonium ethyl(meth)acrylamido chloride or (vinylbenzyl)trimethylammonium chloride; diallyldimethylammonium chloride, alone or as mixtures, or their corresponding salts, or
poly(vinyl alcohol), for example resulting from hydrolysis of a poly(vinyl acetate), or
cyclic amides of vinylamine, such as N-vinylpyrrolidone, or
a hydrophilic monomer originating from a chemical modification of a hydrophobic block, for example by hydrolysis of a poly(alkyl acrylate) to poly(acrylic acid).

Preferably, the hydrophilic monomer units (h) are chosen from acrylic acid (AA), 2-acrylamido-2-methylpropanesulfonic acid (AMPS), styrenesulfonate (SS), N-vinylpyrrolidone, monomers comprising ureido groups, or their mixtures.

More preferably still, use is made of acrylic acid (AA) units or of ethylenic monomers comprising ureido groups.

Mention may be made, among monomers having a hydrophobic nature (H), of:
styrene-derived monomers, such as styrene, α-methylstyrene, para-methylstyrene or para-(tert-butyl)styrene, or
esters of acrylic acid or of methacrylic acid with optionally fluorinated C₁-C₁₂, preferably C₁-C₈, alcohols, such as, for example, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate,
vinyl nitriles comprising from 3 to 12 carbon atoms and in particular acrylonitrile or methacrylonitrile,
vinyl esters of carboxylic acids, such as vinyl acetate, vinyl versatate or vinyl propionate,
vinyl halides, for example vinyl chloride, and
diene monomers, for example butadiene or isoprene.

The hydrophobic monomer units (H) of the block copolymer employed in the preparation of the deposited layer of the invention are preferably esters of acrylic acid with linear or branched C₁-C₈ and in particular C₁-C₄ alcohols, such as, for example, methyl acrylate, ethyl acrylate, propyl acrylate, butyl acrylate or 2-ethylhexyl acrylate, or else styrene derivatives, such as styrene.

The other blocks of the block copolymer employed in the preparation of the deposited layer of the invention can be homopolymers of a monomer chosen from the list of (h) or (H) monomers.

The other blocks of the block copolymer employed in the preparation of the deposited layer of the invention can also be random polymers of at least two monomers chosen from the list of (h) or (H) monomers.

The block copolymers of the invention can also be triblock copolymers.

Mention may in particular be made, as block copolymers which are particularly advantageous in the context of the invention, of diblock copolymers in which the first block is a random copolymer based on acrylic acid and on vinylphosphoric acid, comprising at least 5%, preferably 10% and more preferably still 20% by weight of vinylphosphoric acid with respect to the total weight of the block, and the second block is a poly(butyl acrylate) block and in particular of the poly(acrylic acid-stat-vinylphosphonic acid)-poly(butyl acrylate) diblock copolymers, referred to as PBuA-P(AA-VPA).

These PBuA-P(AA-VPA) copolymers are characterized by an (acrylic acid)/(butyl acrylate) ratio by mass which can be between 10:90 and 90:10 and this ratio is preferably between 10:90 and 50:50.

Other block copolymers which are particularly advantageous in the context of the invention are, for example, block copolymers comprising a block of random copolymer based on acrylic acid and on vinylphosphonic acid, comprising at least 5%, preferably 10% and more preferably still 20% by weight of vinylphosphonic acid with respect to the total weight of the block, and a second block of acrylamide. These copolymers are characterized by an (acrylic acid-stat-vinylphosphonic acid block)/(acrylamide block) ratio by mass which can be between 10:90 and 90:10 and this ratio is preferably between 10:90 and 50:50.

The block copolymers used in the invention generally exhibit a number-average molecular mass of between 1 000 and 100 000. Generally, their number-average molecular mass is between 2 000 and 60 000.

Whatever its precise chemical composition, the block copolymer employed in producing the deposited layer of the invention can advantageously be prepared according to a controlled radical polymerization process carried out in the presence of a control agent.

The term “controlled radical polymerization” is to be understood as a specific radical polymerization process, also denoted by the term of “living polymerization”, in which use is made of control agents such that the polymer chains being formed are functionalized by end groups capable of being able to be reactivated in the form of free radicals by virtue of reversible transfer and/or termination reactions.

Mention may in particular be made, as examples of such polymerization processes, of:
the processes of applications WO 98/58974, WO 00/75207 and WO 01/42312, which employ a radical polymerization controlled by control agents of xanthate type,
the process for radical polymerization controlled by control agents of dithioester type of application WO 97/01478,
the process of application WO 99/03894, which employs a polymerization in the presence of nitroxide precursors,
the process for radical polymerization controlled by control agents of dithiocarbamate type of application WO 99/31144,
the process for radical polymerization controlled by control agents of dithiophosphoro ester type of application PCT/FR01/02374,
the process of application WO 96/30421, which uses atom transfer radical polymerization (ATRP),
the process for radical polymerization controlled by control agents of iniferter type according to the teaching of Otu et al., Makromol. Chem. Rapid. Commun., 3, 127 (1982),
the process for radical polymerization controlled by degenerative transfer of iodine according to the teaching of Tatemoto et al., Jap. 50, 127, 991 (1975), Daikin Kogyo Co Ltd Japan, and Matyjaszewski et al., Macromolecules, 28, 2093 (1995),
the process for radical polymerization controlled by tetraphenylethane derivatives disclosed by D. Braun et al. in Macromol. Symp., 111, 63 (1996), or
the process for radical polymerization controlled by organocobalt complexes described by Wayland et al. in J. Am. Chem. Soc., 116, 7973 (1994).

Generally, it is preferable for the block copolymers employed according to the invention to result from a controlled radical polymerization process employing, as control agent, one or more compounds chosen from dithioesters, thioethers-thiones, dithiocarbamates and xanthates. In a particularly advantageous way, the block copolymers used according to the invention result from a controlled radical polymerization carried out in the presence of control agents of xanthate type.

According to a preferred embodiment, the block copolymer used can be obtained according to one of the processes of applications WO 98/58974, WO 00/75207 or WO 01/42312, which employ a radical polymerization controlled by control agents of xanthate type, it being possible for said polymerization to be carried out in particular under bulk conditions, in a solvent or, preferably, in an aqueous emulsion, so as to directly obtain the copolymer in the form of an aqueous or aqueous/alcoholic solution, or easily applicable at a content of between 0.01 and 50% by mass. A solution of the copolymer at a content of between 0.01 and 50% by weight obtained directly by a polymerization process in the same organic solvent can also be used.

Thus, it is possible to employ a process comprising the following stages:
(a) a controlled radical polymerization is carried out, resulting in the production of a functionalized polymer of use as control agent in a controlled radical polymerization reaction, said stage being carried out by bringing into contact:
ethylenically unsaturated monomer molecules,
a source of free radicals, and
at least one control agent of formula (I): 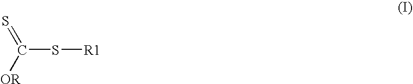
   in which:
   R represents:
      H or Cl;
      an alkyl, aryl, alkenyl or alkynyl group;
      a saturated or unsaturated, optionally aromatic, carbonaceous cycle;
      a saturated or unsaturated, optionally aromatic, heterocycle;
      an alkylthio group,
      an alkoxycarbonyl, aryloxycarbonyl, carboxyl, acyloxy or carbamoyl group;
      a cyano, dialkyl- or diarylphosphonato, or dialkyl- or diarylphosphinato group;
      a polymer chain,
      an (R2)O— or (R2)(R12)N— group, in which the R2 and R′2 radicals, which are identical or different, each represent:
         an alkyl, acyl, aryl, alkenyl or alkynyl group;
         a saturated or unsaturated, optionally aromatic, carbonaceous cycle; or
         a saturated or unsaturated, optionally aromatic, heterocycle;
            and
   R1 represents:
      an alkyl, acyl, aryl, alkenyl or alkynyl group,
      a saturated or unsaturated, optionally aromatic, carbonaceous cycle;
      a saturated or unsaturated, optionally aromatic, heterocycle; or
      a polymer chain,
(b) following stage (a), a controlled radical polymerization stage or several successive controlled radical polymerization stages is/are carried out, said stage(s) each consisting in carrying out a controlled radical polymerization resulting in the production of a functionalized block copolymer of use as control agent in a controlled radical polymerization reaction, said stage or stages being carried out by bringing into contact:
ethylenically unsaturated monomer molecules other than those employed in the preceding stage,
a source of free radicals, and
the functionalized polymer resulting from the preceding stage.

It is understood that one of the polymerization stages (a) and (b) defined above results in the formation of the anchoring block, that is to say, of the block comprising the phosphate and/or phosphonate functional groups, and that another of the polymerization stages of stages (a) and (b) results in the formation of another block. It should in particular be noted that the ethylenically unsaturated monomers employed in the stages (a) and (b) are chosen from suitable monomers in order to obtain a block copolymer as defined above.

The polymerization stages (a) and (b) are generally carried out in a solvent medium composed of water and/or of an organic solvent, such as tetrahydrofuran or a linear, cyclic or branched C₁-C₈ aliphatic alcohol, such as methanol, ethanol or cyclohexanol, or a diol, such as ethylene glycol.

An alcoholic solvent is more particularly recommended in the context of the use of hydrophilic monomers of the type of acrylic acid (AA), of acrylamide (AM), of 2-acrylamido-2-methylpropanesulfonic acid (AMPS) and of styrenesulfonate (SS) and/or in the context of the use of hydrophobic monomers, such as n-butyl acrylate, isobutyl acrylate, 2-ethylhexyl acrylate or t-butyl acrylate.

According to a final aspect, the present invention also relates to the material capable of being obtained by the process described above.

The materials obtained by the use of this process are generally such that they exhibit a strong cohesion between the surface and the coating produced.

Generally, the affinity of the coating for the metal surface is such that the 90° peel strength of this deposited layer at a peel rate of 20 mm/min, measurable, for example, using a dynamometer of Adamel-Lhomargy DY-30 type, is generally greater than or equal to 0.5 N/mm, advantageously greater than 1 N/mm, indeed even than 2 N/mm. In some cases, the peel strength can even be greater than 3 N/mm.

This strong affinity of the coating for the support is naturally reflected by very good stability of the coating on the surface.

In addition, the adhesion of the coating to the surface is not threatened in the presence of water.

Thus, even when the material is kept under 100% relative humidity conditions for a time of 72 hours, the 90° peel strength of the deposited layer generally remains greater than 0.5 N/mm and it is not rare for it to remain greater than 1 N/mm, indeed even than 2 N/mm, at a peel rate of 20 mm/min.

In the case of painted surfaces, the stability of the deposited layer can also be demonstrated by a test of resistance to wet abrasion, according to the DYN 53778 standard, which consists in rubbing the coating obtained with a brush of standardized hardness and standardized weight while dripping thereon water additivated with surfactant, which maintains the wetting of the surface, and in measuring the number of brushing cycles necessary to remove the coating over the whole of its thickness, so as to disclose the support.

In the case of painted surfaces, the stability of the deposited layer can also be demonstrated by a right-angle lattice pattern test, according to the ISO 2409 standard of November 1994, “Paints and varnishes—Cross-cut test”, which consists in evaluating the resistance of a coating to being separated from its metal support when incisions are made therein in the form of a right-angle lattice pattern as far as the support using a cutter and when an attempt is made to pull off a standardized pressure-sensitive transparent adhesive tape adhesively bonded beforehand to the coating.

In the case of painted surfaces, the stability of the deposited layer can also be demonstrated by a cupping test, according to the ISO 1520 standard of June 1995, “Paint and varnishes—Cupping test”, which consists in evaluating the resistance of a coat of paint, varnish or similar product to cracking and/or to detachment from a metal surface when it is subjected to a gradual deformation by cupping under standardized conditions.

In the case of painted surfaces, the stability of the deposited layer can also be demonstrated by a falling weight test, according to the ISO 6272 standard of June 1993, “Paints and varnishes—Falling-weight test”, which consists in evaluating the resistance of a coating to cracking or to detachment from its metal support when it is subjected to a deformation brought about by a falling weight released under standardized conditions.

The advantage of the use of the copolymers of the invention emerges clearly from the use of such tests, where it is found that the strength of an adhesive coating is greatly increased in the presence of these block copolymers.

The subject matter and the advantages of the present invention will become even more clearly apparent in the light of the various implementational examples set out below.

### EXAMPLE 1

### Synthesis of a Diblock Copolymer Based on Acrylamide, on Acrylic Acid and on Vinylphosphonic Acid, Written PAm-Block-P(AA-stat-VPA)

First Block

50 g of a 50% solution of acrylamide in water, 75 g of water, 4 g of acetone, 117 mg of 4,4′-azobis(4-cyanovaleric acid) (ACV) and 174 mg of O-ethyl S-(1-methoxycarbonyl)ethylenyl) xanthate (CH₃CHCO₂CH₃)S(C═S)OEt are introduced into a 500 ml round-bottomed glass flask. The reaction medium is brought to 70° C. for 5 hours.

A sample is subsequently withdrawn and analyzed. Analysis by HPLC chromatography reveals the absence of residual acrylamide. The number-average molar mass is measured by steric exclusion chromatography (SEC) in water calibrated by linear poly(ethylene oxide) standards: Mₙ=24 000 g/mol, M_{w}/Mₙ=1.89.

Second Block

1.32 g of vinylphosphonic acid and 70 mg of ACV are added to the polymer, in solution, resulting from the first stage. The mixture is brought to 70° C. and a solution of 7.14 g of acrylic acid in 34.7 g of water is added over 8 hours. During this introduction, 70 mg of ACV are introduced after 4 hours. This same addition is repeated after 8 hours. The reaction is maintained at this temperature for 5 hours after the end of the introduction of the monomer solution.

A sample is withdrawn and then analyzed. The acrylic acid has been completely converted (HPLC). The conversion of vinylphosphonic acid is 50% (determined by ³¹P NMR).

The block copolymer resulting from this process was purified by dialysis (cutoff threshold of the membrane: 1000 daltons). After dialyzing for 3 days, the copolymer is completely purified from its residual monomer (³¹P NMR). SEC in water gives a measurement of Mₙ=33 300 g/mol, M_{w}/Mₙ=1.74. The controlled nature of the reaction is reinforced by an intense response of the polymer by SEC with UV detection at a wavelength of 290 nm, characteristic of the xanthate group at the chain end of the copolymer.

### EXAMPLE 2

### Synthesis of a Diblock Copolymer Based on Butyl Acrylate, on Acrylic Acid and on Vinylphosphonic Acid, Written PBuA-block-P(AA-stat-VPA)

First Block

20 g of butyl acrylate, 32.6 g of acetone, 219 mg of azobisisobutyronitrile (AIBN) and 1.39 g of O-ethyl S-(1-methoxycarbonyl)ethylenyl) xanthate (CH₃CHCO₂CH₃)S(C═S)OEt are introduced into a 250 ml round-bottomed glass flask. The reaction medium is brought to 70° C. for 5 hours. 109 mg of AIBN are again added 2 hours after the beginning of the reaction.

A sample is subsequently withdrawn and analyzed. The number-average molar mass is measured by SEC calibrated by linear polystyrene standards: Mₙ=2800 g/mol, M_{w}/Mₙ=1.91.

Second Block

10.58 g of vinylphosphonic acid and 219 mg of AIBN are added to the polymer, in solution, resulting from the first stage. The mixture is brought to 70° C. and a solution of 57.14 g of acrylic acid in 100.9 g of water is added over 8 hours. During this introduction, a solution of 328 mg of AIBN in 2 g of acetone is added after 4 hours. This same addition is repeated after 8 hours. The reaction is maintained at this temperature for 5 hours after the end of the introduction of the monomer solution.

A sample is withdrawn and then analyzed. The acrylic acid has been completely converted (HPLC). The conversion of vinylphosphonic acid is 73% (determined by ³¹P NMR).

The block copolymer resulting from this process was purified by dialysis (cutoff threshold of the membrane: 1000 daltons). After dialyzing for 7 days, the copolymer is completely purified from its residual monomer (³¹P NMR). The block copolymer, once purified, exists as a stable dispersion in water.

### EXAMPLE 3

### Synthesis of a Diblock Copolymer Based on Butyl Acrylate, on Acrylic Acid and on Vinylphosphonic Acid, Written PBuA-block-P(AA-stat-VPA)

First Block

20 g of butyl acrylate, 32.6 g of acetone, 219 mg of azobisisobutyronitrile (AIBN) and 1.39 g of O-ethyl S-(1-methoxycarbonyl)ethylenyl) xanthate (CH₃CHCO₂CH₃)S(C═S)OEt are introduced into a 250 ml round-bottomed glass flask. The reaction medium is brought to 70° C. for 5 hours. 109 mg of AIBN are again added 2 hours after the beginning of the reaction.

A sample is subsequently withdrawn and analyzed. The number-average molar mass is measured by SEC calibrated by linear polystyrene standards: Mₙ=2800 g/mol, M_{w}/Mₙ=1.91.

Second Block

3.18 g of vinylphosphonic acid and 219 mg of AIBN are added to the polymer, in solution, resulting from the first stage. The mixture is brought to 70° C. and a solution of 17.14 g of acrylic acid in 29.79 g of water is added over 3 hours. During this introduction, a solution of 328 mg of AIBN in 2 g of acetone is added after 3 hours. This same addition is repeated after 5 hours. The reaction is maintained at this temperature for 5 hours after the end of the introduction of the monomer solution.

A sample is withdrawn and then analyzed. The acrylic acid has been completely converted (HPLC). The conversion of vinylphosphonic acid is 52% (determined by ³¹P NMR).

The block copolymer resulting from this process was purified by dialysis (cutoff threshold of the membrane: 1000 daltons). After dialyzing for 7 days, the copolymer is completely purified from its residual monomer (³¹P NMR). The block copolymer, once purified, exists as a stable dispersion in water.

### EXAMPLE 4

### Use of poly(butyl acrylate)-b-poly(acrylic acid-co-vinylphosphonic acid) and poly(acrylamide)-b-poly(acrylic acid-co-vinylphosphonic acid) Diblock Copolymers According to the Invention for Modifying the Wettability of a Metal Support

The PBuA-b-P(AA-VPA) and PAm-b-P(AA-VPA) diblock copolymers obtained in examples 1, 2 and 3 are employed to modify the wettability of metal surfaces. The metal surfaces used for these tests are standard surfaces supplied by Q Panel, i.e. type R46 steel and type A-36 aluminum, used without additional preparation.

The surface treatment is carried out by dipping the surfaces to be treated in 0.1% by mass aqueous solutions of block copolymer overnight under two different pH conditions, i.e. either the natural pH of the polymer solution after synthesis (pH≈3) or adjusted by sodium hydroxide until a pH of 8.5 is obtained. The presence of polymer at the surface is characterized by measurements of contact angle of a drop of water. These measurements are carried out using an ITC tensiometer of SDT200 type.

TABLE I
Contact angles on an aluminum substrate treated
with a solution of polymer PAm-P (AA-VPA): 30K-10K

| | Angle (°) |
|---|---|
| Without treatment | 93 |
| PAm-P (AA-VPA): 30K-10K at pH = 2.5 | 51 |
| PAm-P (AA-VPA): 30K-10K at pH = 8.5 | 53 |

TABLE II
Contact angles on an aluminum substrate
treated with a solution of polymer PAm-P (AA-VPA):
30K-10K, and then washed with purified water for 24 h

| | Angle (°) |
|---|---|
| Without treatment | 93 |
| PAm-P (AA-VPA): 30K-10K at pH = 2.5 | 50 |
| PAm-P (AA-VPA): 30K-10K at pH = 8.5 | 59 |

In the case of aluminum, relatively hydrophobic without preliminary treatment, it is possible to render its surface hydrophilic in a significant (cf. table I) and lasting (cf. table II) way. This is because, by treatment with a PAm-b-P(AA-VPA) polymer, at acidic or basic pH, the contact angle significantly decreases from 90 to 50° approximately.

The durability of this treatment is demonstrated by washing the samples in purified water for 24 h. In this case, the contact angles after washing are substantially identical to those measured directly after treatment (cf. table II).

TABLE III
Tests on a steel substrate
treatd at pH = 8.5

| | Angle (°) |
|---|---|
| Without treatment | 62 |
| PAm-P (AA-VPA): 30K-10K | 11 |
| PBuA-P (AA-VPA): 3K-10K | 64 |
| PBuA-P (AA-VPA): 3K—3K | 79 |

On a relatively hydrophilic steel substrate, it is possible to adjust its wettability using an amphiphilic polymer. Thus, depending on the HLB of the polymer used, it is possible to render the surface either hydrophilic (with PAm-P(AA-VPA): 30K-10K) or hydrophobic (with PBuA-P(AA-VPA): 3K-3K) (cf. table III).

### EXAMPLE 5

### Use of poly(butyl acrylate)-b-poly(acrylic acid-co-vinylphosphonic acid) and poly(acrylamide)-b-poly(acrylic acid-co-vinylphosphonic acid) Diblock Copolymers According to the Invention for Improving the Effectiveness of the Deposition of a Latex on a Metal Support

The PBuA-b-P(AA-VPA) and PAm-b-P(AA-VPA) diblock copolymers obtained in examples 1, 2 and 3 are employed in carrying out the deposition of an adhesion primer coat on various flat supports made of steel and aluminum. The surface treatment is carried out by dipping the surfaces to be treated in 0.1% by mass aqueous solutions of block copolymer.

Latex is subsequently deposited on the surfaces thus treated in order evaluate the properties of adhesion of the film obtained after drying. By way of comparison, a latex film is produced on an untreated control surface.

The latex used in the context of the various tests carried out in this example is an industrial acrylic latex used in particular in decorative paint, sold by Rhodia under the reference DS 1003.

It is an aqueous dispersion of particles of styrene/butyl acrylate copolymers, the mean diameter of which is 0.15 microns, characterized by a polymer content of 50% by mass.

The metal surfaces used for these tests are standard surfaces supplied by Q Panel, i.e. type R46 steel and type A-36 aluminum, used without additional preparation.

The samples are subjected to aging for 7 days before the peel strength measurements. The storage and the tests are carried out in a climate-controlled chamber at 22° C. (+/−3° C.) and under relative humidity conditions of 55% (+/−5%).

With the exception of the control surfaces, the surfaces are dipped in 0.1% by mass aqueous solutions of block copolymer overnight under two different pH conditions, i.e. either the natural pH of the polymer solution after synthesis (pH≈3) or adjusted by sodium hydroxide until a pH of 8.5 is obtained.

After treatment, the excess solution is sponged off and a latex film is produced using a film drawer, so as to produce a latex film with a thickness of 1 mm (before drying) which is immediately covered with a silk cloth which makes it possible to carry out a 90° peel test on the coating.

The samples are subsequently placed for 7 days in a climate-controlled chamber at 22° C. (+/−3° C.) and under relative humidity conditions of 55% (+/−5%).

A 90° peel test is subsequently carried out on the coating. It consists in pulling a strip of coating perpendicularly to the surface of the support until the coating becomes detached from the surface.

The mean force necessary to bring about this separation is measured using an Adamel-Lhomagry dynamometer of DY-30 type with a sensor of 100 N maximum.

At the end of this test, the force is related to the width of the strip of adhesive peeled off in order to finally express the peel strength per unit of width (Fₚ) in N/mm.

The results obtained with a peel rate of 20 mm/min are combined in tables I to III below.

TABLE I
Peel tests on an aluminum substrate at pH = 8.5

| | Fₚ (N/mm) |
|---|---|
| Control | 1.5 |
| PAm-P (AA-VPA): 30K-10K | 1.8 |
| PBuA-P (AA-VPA): 3K-10K | 1.2 |
| PBuA-P (AA-VPA): 3K—3K | 1.1 |

TABLE II
Peel tests on an aluminum substrate at pH = 2.5

| | Fₚ (N/mm) |
|---|---|
| Control | 1.5 |
| PAm-P (AA-VPA): 30K-10K | 2.7 |
| PBuA-P (AA-VPA): 3K-10K | 2.4 |
| PBuA-P (AA-VPA): 3K—3K | 2.3 |

Adhesion is improved on an aluminum substrate, in particular with PAm-P(AA-VPA): 30K-10K at basic pH and with the three polymers of examples 1, 2 and 3 at acidic pH (cf. tables I and II).

TABLE III
Peel tests on a steel substrate

| | Fₚ (N/mm) |
|---|---|
| Control | 2.5 |
| PAm-P (AA-VPA): 30K-10K at pH = 8.5 | 2.5 |
| PAm-P (AA-VPA): 30K—10K at pH = 2.5 | 4.0 |

Adhesion is improved on a steel substrate with treatment by the polymer PAm-P(AA-VPA): 30K-10K, in particular at acidic pH (cf. table III). By way of indication, on steel treated with phosphoric acid (supplied by Q Panel under the reference R46i), regarded as an adhesion promoter and a corrosion inhibitor, the peel strength under the same conditions is 3.3 N/mm.

1-39. (canceled)

40. A process for increasing the affinity of a metal surface with respect to water, comprising the step of depositing on said surface a layer of a block copolymer, whose at least one block has phosphate and/or phosphonate functional groups, said copolymer optionally being dissolved in a solvent, water or a water/alcohol mixture.

41. A process for rendering effective and lasting a subsequent application of a composition (F) on a metal surface, comprising the step of depositing first on said metal surface a layer of a block copolymer whose at least one block has phosphate and/or phosphonate functional groups, said copolymer optionally being dissolved in a solventwater or a water/alcohol mixture.

42. A process for protecting a metal surface from corrosion, comprising the step of depositing on said surface a layer of a block copolymer whose at least one block has phosphate and/or phosphonate functional groups, said copolymer optionally being dissolved in a solvent, water or a water/alcohol mixture.

43. The process as claimed in claim 41, wherein the deposited layer based on said block copolymer is produced by applying, to said metal surface, a solution comprising this block copolymer or by immersing said metal surface in a solution based on the block copolymer, and by then at least partially removing the solvent initially present in this solution.

44. The process as claimed in claim 41, wherein the metal of the metal surface is an alkali metal, an alkaline earth metal, a transition metal, aluminum, gallium, indium, thallium, silicon, germanium, tin, lead, arsenic, antimony, bismuth, tellurium, polonium, astatine, their oxides or their alloys.

45. The process as claimed in claim 44, wherein the metal surface is aluminum, duralumin, zinc, tin, copper, bronze, brass, iron, steel, optionally stainless or galvanized, silver or vermeil.

46. The process as claimed in claim 41, wherein the deposited layer of block copolymer is produced in the form of a continuous film.

47. The process as claimed in claim 41, wherein the block comprising phosphate and/or phosphonate functional groups is a homopolymer based on a monomer comprising phosphate or phosphonate functional groups.

48. The process as claimed in claim 41, wherein the block comprising phosphate and/or phosphonate functional groups is a random polymer based on at least one monomer comprising one or other of said phosphate or phosphonate functional groups or their mixtures in an amount of between 0.1 and 100% by weight of said monomers with respect to the total weight of the block.

49. The process as claimed in claim 48, wherein the amount of said monomers is between 0.5% and 50% by weight of said monomers with respect to the total weight of the block.

50. The process as claimed in claim 48, wherein the amount of said monomers is between 2% and 20% by weight of said monomers with respect to the total weight of the block.

51. The process as claimed in any one of claims 47, wherein the monomer comprising phosphate or phosphonate functional groups is:
N-methacrylamidomethylphosphonic acid ester derivative,
N-methacrylamidoethylphosphonic acid ester derivative,
N-acrylamidomethylphosphonic acid ester derivative,
vinylbenzylphosphonate dialkyl ester derivative,
diethyl 2-(4-vinylphenyl)ethanephosphonate,
dialkylphosphonoalkyl acrylate and methacrylate derivatives,
vinylphosphonic acid, optionally substituted by cyano, phenyl, ester or acetate groups, vinylidene-phosphonic acid, in the sodium salt form or the form of its isopropyl ester, or bis(2-chloroethyl)vinylphosphonate,
acrylate of polyethylene glycol omega phosphates,
methacrylate of polyethylene glycol omega phosphates,
acrylates of polypropylene glycol omega phosphates, or
methacrylate of polypropylene glycol omega phosphates.

52. The process as claimed in claim 51, wherein the monomer comprising phosphate or phosphonate functional groups is:
N-methacrylamidomethylphosphonic n-propyl ester,
N-methacrylamidomethylphosphonic methyl ester,
N-methacrylamidomethylphosphonic ethyl ester,
N-methacrylamidomethylphosphonic n-butyl ester,
N-methacrylamidomethylphosphonic isopropyl ester,
N-methacrylamidomethylphosphonic diacid,
N-methacrylamidoethylphosphonic acid dimethyl ester.
N-methacrylamidoethylphosphonic acid di(2-butyl-3,3-dimethyl)ester
N-methacrylamidoethylphosphonic diacid,
N-acrylamidomethylphosphonic acid dimethyl ester,
N-acrylamidomethylphosphonic acid diethyl ester,
bis(2-chloropropyl) N-acrylamidomethylphosphonate,
N-acrylamidomethylphosphonic acid,
vinylbenzylphosphonate dialkyl di(n-propyl),
vinylbenzylphosphonate dialkyl ester di(isopropyl),
vinylbenzylphosphonate dialkyl ester diethyl,
vinylbenzylphosphonate dialkyl ester dimethyl,
vinylbenzylphosphonate dialkyl ester di(2-butyl-3,3-dimethyl),
vinylbenzylphosphonate dialkyl ester di(t-butyl),
vinylbenzylphosphonic diacid,
2-(acryloyloxy)ethylphosphonic acid dimethyl ester,
2-(methacryloyloxy)ethylphosphonic acid dimethyl ester,
2-(methacryloyloxy)methylphosphonic acid diethyl ester,
2-(methacryloyloxy)methylphosphonic acid dimethyl ester,
2-(methacryloyloxy)propylphosphonic acid dimethyl ester,
2-(acryloyloxy)methylphosphonic acid diisopropyl ester,
2-(acryloyloxy)ethylphosphonic acid diethyl ester,
2-(methacryloyloxy)ethylphosphonic acid,
2-(methacryloyloxy)methylphosphonic acid,
2-(methacryloyloxy)propylphosphonic acid,
2-(acryloyloxy)propylphosphonic acid, or
2-(acryloyloxy)ethylphosphonic acid.

53. The process as claimed in claim 41, wherein the block copolymer is obtained as the result of a controlled radical polymerization process optionally using, as control agent, a dithioester, a thioethers-thione, a dithiocarbamate or a xanthate, said polymerization being carried out under bulk conditions, in a solvent or in an aqueous emulsion, so as to directly obtain the copolymer in the form of a solution in a solvent, water or a water/alcohol mixture.

54. The process as claimed in claim 53, wherein the solution of block copolymer has a content of between 0.01 and 50% by mass, this content being expressed with respect to the total mass of the solution.

55. The process as claimed in claim 54, wherein the solution of block copolymer has a content of between 0.05 and 10% by mass, this content being expressed with respect to the total mass of the solution.

56. The process as claimed in claim 54, wherein the solution of block copolymer has a content of between 0.1 and 5% by mass, this content being expressed with respect to the total mass of the solution.

57. The process as claimed in claim 54, wherein the block copolymer is deposited in the form of a film with a thickness of between 10 nm and 1 μm.

58. A process for the application of a film-forming composition (F) to a metal surface, comprising the following stages:
(A) applying to said surface a formulation optionally comprising a solvent, such as an organic solvent, water or a water/alcohol mixture, comprising a block copolymer, whose at least one block has phosphate and/or phosphonate functional groups, so as to form, on said surface, a deposited layer in the form of a continuous coat; and
(B) removing at least partially the solvent from the deposited layer obtained in stage (A); and
(C) applying said film-forming composition (F) to the surface, thus modified, obtained in stage (B).

59. The process as claimed in claim 58, wherein the composition (F) is an aqueous dispersion of at least one polymer.

60. The process as claimed in claim 58, wherein the composition (F) is an organic solution of at least one polymer.

61. The process as claimed in claim 58, wherein the composition (F) is based on anhydrous mastic or polyurethane of at least one polymer.

62. The process as claimed in claim 61, wherein, in stage (C), the aqueous composition (F) is applied in the form of a continuous film to the deposited layer based on the block copolymer.

63. The process as claimed in claim 58, wherein, following the application of said composition (F) of stage (C), the surface covered by said composition (F) is further subjected to a stage (D) for removal of the solvent phase present in the composition applied.

64. The process as claimed in claim 58, wherein the composition (F) is an optionally silicone-comprising mastic composition, paint composition or adhesive composition.
